(19) United States
(12) Patent Application Publication
(10) Pub. No.: US 2003/0052470 A1
(43) Pub. Date: Mar. 20, 2003

(54) Holder for a handlebar of a bicycle

(76) Inventor: Tu-Kun Lee, Chang Hwa Hsien (TW)

Correspondence Address: VENABLE, BAETJER, HOWARD AND CIVILETTI, LLP, P.O. BOX 34385, WASHINGTON, DC, 20043-9998, US

(21) Appl. No.: 09/955,200

(22) Filed: Sep. 19, 2001

(51) Int. Cl. B62M 3/00

(52) U.S. Cl. 280/281.1; 280/263

(57) ABSTRACT

A holder for a handlebar of a bicycle in accordance with the present invention includes a connecting bar having a first end secured on a stem of a bicycle and a second end having a loop attached the connecting bar. The loop is provided to receive a handlebar of a bicycle and having an axis inclined relative to and forming an acute angle with that of the stem of a bicycle. A quick release device extends through the connecting bar and is mounted on the connecting bar to selectively hold the handlebar of a bicycle in place.

### BACKGROUND OF THE INVENTION

1. Field of the Invention

The present invention relates to a holder, and more particularly to a holder for a handlebar of a bicycle.

2. Description of Related Art

There is no connecting device for connecting the stem and the handlebar of a conventional bicycle so that the stem and the handlebar are fixedly mounted to each other. Consequently, the height of the handlebar is fixed and the rider has not enough space to stretch his hands and legs so that the rider will have a sore waist and an aching back after riding for a long time.

The present invention has arisen to mitigate and/or obviate the disadvantages of the conventional connecting way of the stem and the handlebar of a bicycle.

### SUMMARY OF THE INVENTION

The main objective of the present invention is to provide an improved holder for a handlebar of a bicycle.

To achieve the objective, the holder for a handlebar of a bicycle in accordance with the present invention includes a connecting bar having a first end adapted to be secured on a stem of a bicycle and a second end having a loop attached the connecting bar. The loop is provided to receive a handlebar of a bicycle and having an axis inclined relative to and forming an acute angle with that of the stem of a bicycle. A quick release device extends through the connecting bar and is mounted on the connecting bar to selectively hold the handlebar of a bicycle in place.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a holder for a handlebar of a bicycle in accordance with the present invention in combination with a stem of the bicycle;

FIG. 2 is a partially exploded perspective view of the holder for a handlebar of a bicycle in FIG. 1;

FIG. 3 is an operational side plan view of the holder for a handlebar of a bicycle in FIG. 1;

FIG. 4 is a partially exploded perspective view of another embodiment in accordance with the present invention; and

FIG. 5 is a top plan view of the holder for a handlebar of a bicycle in FIG. 4.

### DETAILED DESCRIPTION OF THE INVENTION

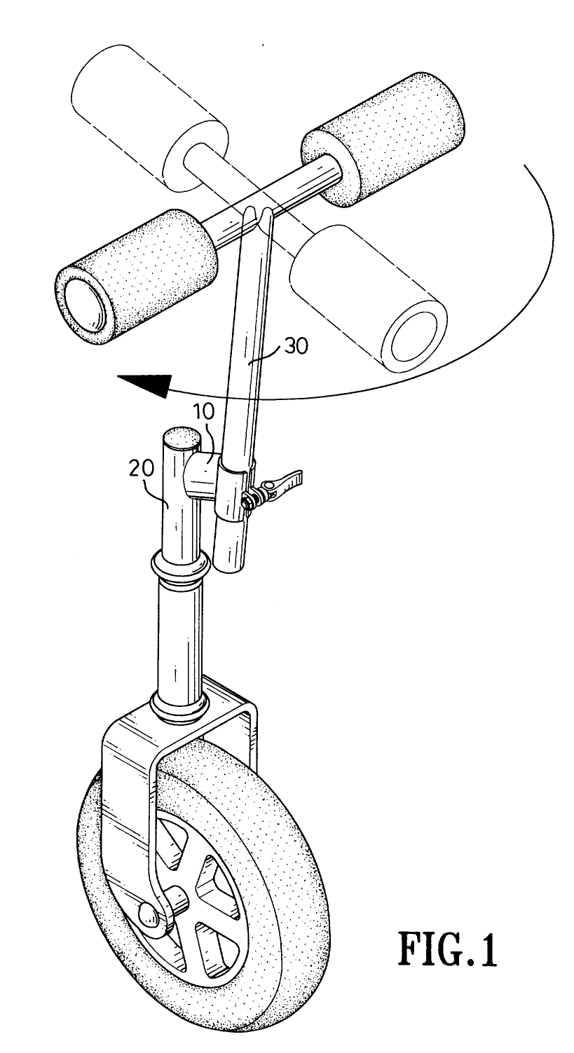

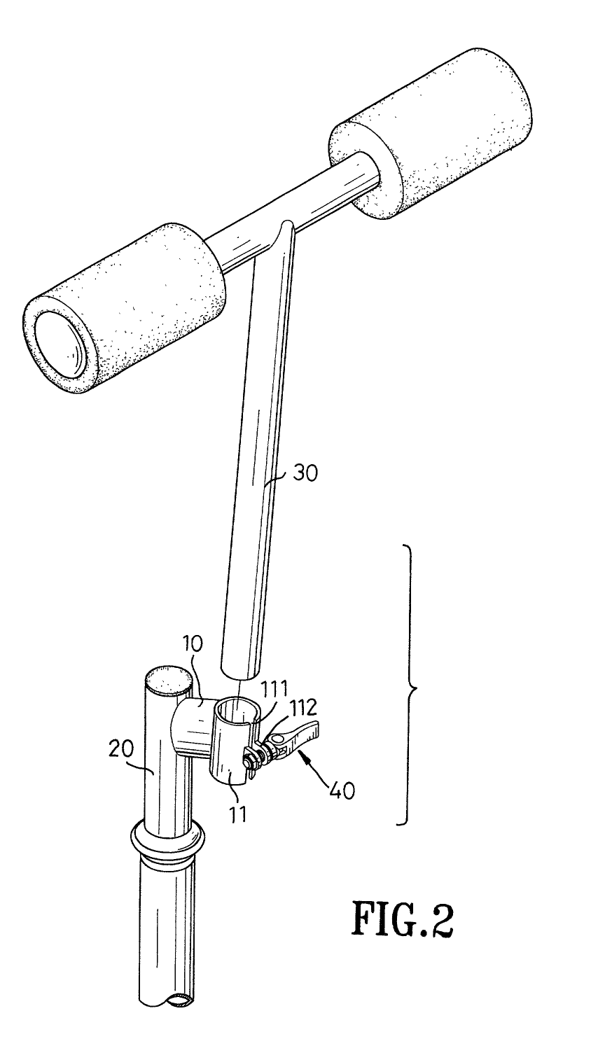

Referring to the drawings and initially to FIGS. 1 and 2, a holder for a handlebar of a bicycle in accordance with the present invention comprises a connecting bar (10) with a first end adapted to be toward secured on a stem (20) of a bicycle and a second end having a loop (11) attached to the connecting bar (10). A slit (111) is defined in a periphery of the loop (11) and extends through the loop (11). The loop (11) has two ears (112) respectively laterally extending from the periphery of the loop (11) near the two opposite sides of the slit (111). The two ears (112) correspond to each other and each has a through hole (not shown) defined to aligning with each other. The loop (11) is adapted to receive a handlebar (30) and a quick release device extends through hole of each of the ears (112) to narrow the width of the silt (111) to selectively hold the handlebar (30) in place.

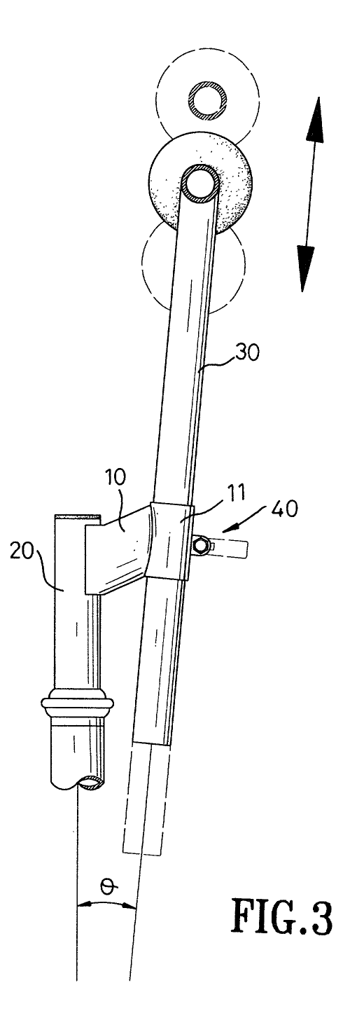

With reference to FIG. 3, the height of the handlebar (30) is easy to be adjusted due to the function of the quick release device (40). The loop (11) has an axis inclined relative to that of the stem (20) of the bicycle and forms an acute angle (θ) with that of the stem (20) of the bicycle. In the preferred embodiment of the present invention, the acute angle is five degrees. Consequently, the horizontal distance between the stem (20) and the top of the handlebar (30) increases gradually due the acute angle (θ).

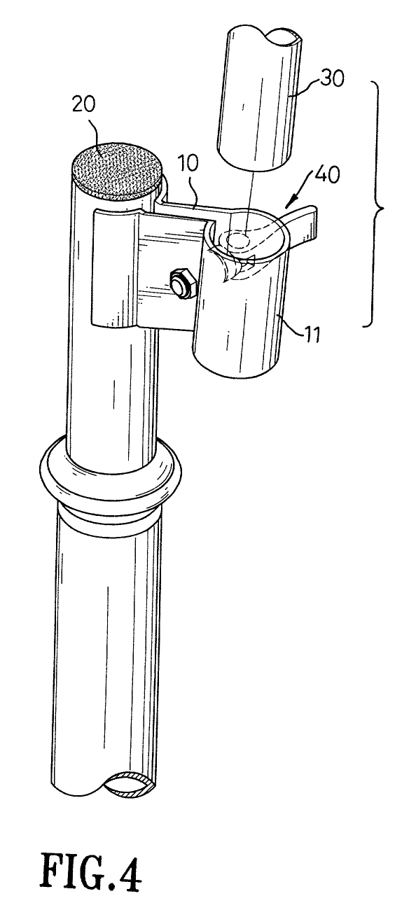

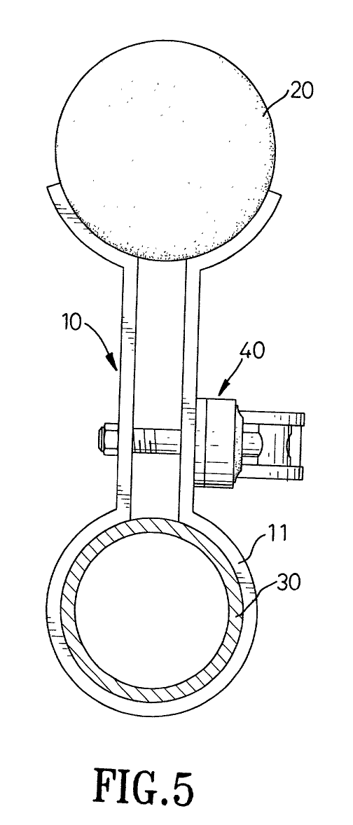

With reference to FIGS. 4 and 5 that show another embodiment of the holder for a handlebar of a bicycle in accordance with the present invention. The connecting bar (10) of the embodiment is designed to be two plates parallel to each other. Each of the plates has a first end adapted to be secured on the stem (20) of the bicycle and a second end having a loop (11) attached to the connecting bar (10). The loop (11) has a slit (111) defined in a periphery of the loop (11) and extending through the loop (11). The slit (111) is situated between the two plates of the connecting bar (10). The loop (11) is adapted to receive the handlebar (30) of the bicycle. A quick release device (40) extends through the connecting bar (10) to narrow the width of the two parallel plates and the width of the slit (111) to selectively hold the handlebar (30) in place.

As described above, the holder for a handlebar of a bicycle in accordance with the present invention has several advantages as follow.

1. The rider has a greater space to stretch his hands and legs because the handlebar extends toward when the handlebar is adjusted tally to prevent the rider from having a sore waist and an aching back after riding for a long time.

2. The structure of the present invention is simplified so that it is easy to manufacture and reduce the cost of manufacturing.

3. The fixing device of the present invention is a quick release device so that the height of the handlebar of the bicycle is able to be adjusted easily and quickly.

Although the invention has been explained in relation to its preferred embodiment, it is to be understood that many other possible modifications and variations can be made without departing from the spirit and scope of the invention as hereinafter claimed.

What is claimed is:

1. A holder for a handlebar of a bicycle comprising:
a connecting bar having a first end adapted to be secured on a stem of a bicycle and a second end having a loop attached the connecting bar, the loop adapted to receive a handlebar of a bicycle and having an axis adapted to be inclined relative to and forming an acute angle with that of the stem of a bicycle; and
a quick release device extending through the connecting bar and mounted on the connecting bar to be adapted to selectively hold the handlebar of a bicycle in place.

2. The holder for a handlebar of a bicycle as claimed in claim 1, wherein the acute angle is five degrees.

3. The holder for a handlebar of a bicycle as claimed in claim 1, wherein the loop comprises a slit defined in a periphery and extending through the periphery of the loop, and two ears respectively laterally extending from the periphery of the loop near two opposite sides of the slit, the two ears corresponding to each other and each having a through hole defined to align with each other, the quick release device extending through the two through of the ears to narrow a width of the slit and adapted to hole the handlebar of a bicycle in place.

4. The holder for a handlebar of a bicycle as claimed in claim 1, wherein the connecting comprises two parallel plates each having a first end adapted to be secured on the stem of a bicycle and a second end, the loop attached to the second end of the two plates and having a slit defined between the two plates, the quick release device extending through the two plates and mounted on the connecting bar to narrow a width of the two parallel plates and a width of the slit and adapted to hole the handlebar of a bicycle in place.

5. The holder for a handlebar of a bicycle as claimed in claim 2, wherein the loop comprises a slit defined in a periphery and extending through the periphery of the loop, and two ears respectively laterally extending from the periphery of the loop near two opposite sides of the slit, the two ears corresponding to each other and each having a through hole defined to align with each other, the quick release device extending through the two through of the ears to narrow a width of the slit and adapted to hole the handlebar of a bicycle in place.

6. The holder for a handlebar of a bicycle as claimed in claim 2, wherein the connecting comprises two parallel plates each having a first end adapted to be secured on the stem of a bicycle and a second end, the loop attached to the second end of the two plates and having a slit defined between the two plates, the quick release device extending through the two plates and mounted on the connecting bar to narrow a width of the two parallel plates and a width of the slit and adapted to hole the handlebar of a bicycle in place.
